(19) United States
(12) Patent Application Publication
(10) Pub. No.: US 2025/0232905 A1
(43) Pub. Date: Jul. 17, 2025

(54) TRANSFORMER MODULE

(71) Applicant: MOTIVELINK CO.,Ltd, Yongin-si (KR)

(72) Inventors: Hyung Suk SONG, Cheonan-si (KR); Seung Won CHOI, Ansan-si (KR); Hyun Yong JOO, Gwangju-si (KR); Seon Yeong JUNG, Yongin-si (KR)

(73) Assignee: MOTIVELINK CO.,Ltd, Yongin-si (KR)

(21) Appl. No.: 19/060,692

(22) Filed: Feb. 23, 2025

Related U.S. Application Data
(63) Continuation of application No. PCT/KR2023/006487, filed on May 12, 2023.

(30) Foreign Application Priority Data
Dec. 2, 2022 (KR) 10-2022-0167013
May 11, 2023 (KR) 10-2023-0061309

(51) Int. Cl. H01F 27/02; H01F 27/29; H01F 27/32

(52) U.S. Cl. CPC H01F 27/02; H01F 27/29; H01F 27/325

(57) ABSTRACT

A transformer module according to an embodiment of the present disclosure may include a first transformer unit configured to perform first power conversion, a second transformer unit spaced apart from the first transformer unit, and configured to perform second power conversion, and a packaging unit including the first transformer unit and the second transformer unit, and connecting the first transformer unit and the second transformer unit to a substrate to allow for electrical conduction. The packaging unit may include a first bobbin unit formed on one side and configured to receive the first transformer unit, and a second bobbin unit formed on an opposite side spaced apart from the first bobbin unit, and configured to receive the second transformer unit.

### CROSS-REFERENCE TO RELATED APPLICATIONS

This application is a continuation application of International Application No. PCT/KR2023/006487, filed May 12, 2023, which claims the benefit of Korean Patent Application No. 10-2022-0167013, filed Dec. 2, 2022 and No. 10-2023-0061309, filed May 11, 2023, in the Korean Intellectual Property Office, the disclosures of which are incorporated herein in their entirety by reference.

### TECHNICAL FIELD

The present disclosure relates to a transformer module, and more particularly, to a resonant transformer module in a series-parallel hybrid connection configuration.

### BACKGROUND ART

Transformers are devices used to increase or decrease alternating current (AC) voltage based on a principle of mutual induction. Transformers are used across a wide range of industries for using electricity, converting an input voltage applied to an input terminal into an output voltage at an output terminal. Therefore, the transformers may provide voltage and/or power suitable for devices or the like connected to the output terminal.

Generally, in the case of a circuit using two or more transformers, identical transformers are arranged in parallel, and each of the transformers is connected in a series structure, parallel structure, or series-parallel hybrid structure using circuit patterns on a substrate (e.g., a PCB).

However, as described above, when forming a series, parallel, or series-parallel connection structure of two or more transformers using circuit patterns on a substrate, a plurality of substrate layers are required to implement a corresponding circuit pattern, leading to inefficient use of substrate space, and raising concerns about excessive increase in the thickness of the substrate.

More specifically, because at least four circuit patterns, including primary-side patterns and secondary-side patterns for each transformer, need to be formed, there is an issue in that the substrate is required to be configured in consideration of a safety distance between the respective circuit patterns. Furthermore, when forming a circuit pattern for parallel connection, there is an issue in that the thickness of the circuit pattern before and after a point at which a transformer is connected needs to vary, taking into account wiring resistance or the like.

Accordingly, studies have been conducted on transformer structures capable of implementing two or more transformers while simplifying the circuit patterns formed on such a substrate.

### DISCLOSURE

### Technical Problem

To overcome the aforementioned problems, embodiments of the present disclosure are intended to provide a transformer module in which coils are wound in a single package form, implementing a series, parallel, or series-parallel hybrid connection configuration in a package rather than on a substrate.

Furthermore, embodiments of the present disclosure are intended to provide a transformer module in which at least respective portions of a first coil unit and a second coil unit are formed to overlap each other, thus allowing for adjustment of leakage inductance.

Furthermore, embodiments of the present disclosure are intended to provide a transformer module in which at least respective portions of the first coil unit and the second coil unit are formed to overlap each other, thus allowing for adjustment of leakage inductance, and in addition, preventing short-circuiting between the first coil unit and the second coil unit.

The technical objects of the present disclosure are not limited to the objects mentioned above, and other technical objects not mentioned may be clearly understood by those skilled in the art from the following description.

### Technical Solution

A transformer module according to an embodiment of the present disclosure may include a first transformer unit configured to perform first power conversion, a second transformer unit spaced apart from the first transformer unit, and configured to perform second power conversion, and a packaging unit including the first transformer unit and the second transformer unit, and connecting the first transformer unit and the second transformer unit to a substrate to allow for electrical conduction. The packaging unit may include: a first bobbin unit formed on one side to receive the first transformer unit, and a second bobbin unit formed on an opposite side spaced apart from the first bobbin unit to receive the second transformer unit.

Furthermore, the transformer module may further include a first coil unit placed on respective input terminals of the first transformer unit and the second transformer unit, and a second coil unit placed on respective output terminals of the first transformer unit and the second transformer unit. At least a portion of the first coil unit and at least a portion of the second coil unit may be included in the first transformer unit, and a remaining portion of the first coil unit and a remaining portion of the second coil unit may be included in the second transformer unit.

Furthermore, the first coil unit may include a first coil placed on the input terminal of the first transformer unit, and a second coil connected in series to the first coil, and placed on the input terminal of the second transformer unit. The second coil unit may include a third coil placed on the output terminal of the first transformer unit, and a fourth coil connected in parallel with the third coil, and placed on the output terminal of the second transformer unit.

Furthermore, the first bobbin unit may include a first winding area where the first coil is wound, a second winding area where the third coil is wound, and a first overlapping area where the first coil and the third coil overlap each other by a first overlapping length. The first overlapping area may occupy at least a portion of the first winding area or the second winding area. The second bobbin unit may include a third winding area where the second coil is wound, a fourth winding area where the fourth coil is wound, and a second overlapping area where the second coil and the fourth coil overlap each other by a second overlapping length. The second overlapping area may occupy at least a portion of the third winding area or the fourth winding area.

Furthermore, leakage inductance on the first transformer unit may be adjusted in correspondence with the first overlapping length of the first overlapping area, and leakage inductance on the second transformer unit may be adjusted in correspondence with the second overlapping length of the second overlapping area.

Furthermore, the packaging unit may further include a bobbin coupling unit coupled to one side of each of the first bobbin unit and the second bobbin unit, and provided to secure and seat the packaging unit on the substrate. The bobbin coupling unit may include a plurality of terminals by which the first coil unit and the second coil unit are connected to the substrate to allow for electrical conduction.

Furthermore, the plurality of terminals may include a first terminal to which a first end of the first coil unit is coupled, a second terminal to which a second end of the first coil unit is coupled, a third terminal to which a first end of the second coil unit is coupled, and a fourth terminal to which a second end of the second coil unit is coupled. A first end of the first coil in the first coil unit may be connected to the first terminal through a first hole among a plurality of holes formed in the bobbin coupling unit. A second end of the first coil may be electrically connected to a first end of the second coil in the first coil unit through a connection bridge. A second end of the second coil may be connected to the second terminal through a second hole among the plurality of holes.

Furthermore, a first end of the third coil and a first end of the fourth coil in the second coil unit may be connected to the third terminal through a third hole among the plurality of holes. A second end of the third coil and a second end of the fourth coil may be connected to the fourth terminal through a fourth hole among the plurality of holes.

Furthermore, the first coil unit may be wound with a first diameter, and the second coil unit may be wound with a second diameter less than the first diameter, so that at least a portion of the second coil unit may be inserted into the first coil unit.

Furthermore, the first coil in the first coil unit and the fourth coil in the second coil unit may be wound with a first diameter, and the second coil in the first coil unit and the third coil in the second coil unit may be wound with a second diameter less than the first diameter, so that at least a portion of the third coil may be inserted into the first coil, and at least a portion of the second coil may be inserted into the fourth coil.

Furthermore, the first coil unit may be wound with a second diameter, and the second coil unit may be wound with a first diameter greater than the second diameter, so that at least a portion of the first coil unit may be inserted into the second coil unit.

Furthermore, the second coil in the first coil unit and the third coil in the second coil unit may be wound with a first diameter, and the first coil in the first coil unit and the fourth coil in the second coil unit may be wound with a second diameter less than the first diameter, so that at least a portion of the first coil may be inserted into the third coil, and at least a portion of the fourth coil may be inserted into the second coil.

Furthermore, at least one of the first bobbin unit and the second bobbin unit may include a coil guide unit configured to guide at least one of the first coil unit and the second coil unit. The coil guide unit may include a plurality of coil guiding columns formed to protrude upward by a set height, and at least one coil passing space formed between the plurality of coil guiding columns.

Furthermore, the first bobbin unit may include a first coil partition configured to separate the first winding area and the second winding area. The second bobbin unit may include a second coil partition configured to separate the third winding area and the fourth winding area.

Furthermore, a portion of the first coil in the first coil unit may cross over the first coil partition, extend into the second winding area, in which the third coil is wound, and form the first overlapping area. A portion of the second coil in the first coil unit may cross over the second coil partition, extend into the fourth winding area, in which the fourth coil is wound, and form the second overlapping area.

Furthermore, the transformer module may further include an insulator covering an outer circumferential surface of at least one of the portion of the first coil that forms the first overlapping area and the portion of the third coil that forms the first overlapping area, or covering an outer circumferential surface of at least one of the portion of the second coil that forms the second overlapping area and the portion of the fourth coil that forms the second overlapping area.

### Advantageous Effects

According to the proposed embodiments, by using a transformer module according to an embodiment of the present disclosure, a series-parallel connection structure may be implemented in a module through a wound configuration of coils and a connection structure between the coils without the need for a complex pattern on a substrate (e.g., a PCB), thereby providing the advantages of simplifying a substrate design and enabling miniaturization of devices using the transformer module.

Furthermore, a method of assembling a device including the transformer module is simplified, thereby improving assemblability, reducing assembly time, and decreasing assembly costs.

By using the transformer module according to an embodiment of the present disclosure, a first coil unit and a second coil unit partially overlap each other, thus allowing for adjustment of leakage inductance, which is one of the key factors in an inductor-inductor-capacitor (LLC) resonant circuit, thereby providing the advantage of maximizing the voltage transformation efficiency through the adjustment (reduction) of leakage inductance.

Furthermore, in the transformer module according to an embodiment of the present disclosure, due to a coil guide unit for guiding at least one of the first coil unit and the second coil unit, the first coil unit and the second coil unit may be positioned at correct positions, and opposite ends of the first coil unit and opposite ends of the second coil unit may be organized.

In the transformer module according to an embodiment of the present disclosure, an insulator covering outer circumferential surfaces of portions of the coils in first and second overlapping areas in which the coils overlap each other can prevent electrical contact (short-circuiting) in areas vulnerable to withstand voltage stress between the coils, thereby improving the stability of the transformer module.

### DESCRIPTION OF DRAWINGS

FIG. 1 is a perspective view of a transformer module according to an embodiment of the present disclosure.

FIG. 2 is a plan view of the transformer module according to an embodiment of the present disclosure.

FIG. 3 is a sectional view of the transformer module according to an embodiment of the present disclosure.

FIG. 4 illustrates a structure in which at least respective portions of a first coil unit and a second coil unit overlap each other in the transformer module according to an embodiment of the present disclosure.

FIG. 5 is a sectional view of a transformer module according to a first embodiment of the present disclosure.

FIG. 6 is a sectional view of a transformer module according to a second embodiment of the present disclosure.

FIG. 7 is a sectional view of a transformer module according to a third embodiment of the present disclosure.

FIG. 8 is a sectional view of a transformer module according to a fourth embodiment of the present disclosure.

FIG. 9 is a perspective view of a transformer module according to a fifth embodiment of the present disclosure.

FIG. 10 is a plan view of the transformer module according to the fifth embodiment of the present disclosure.

[Description Reference Numerals]

| | |
|---|---|
| 1, 2: transformer module | 100: first transformer unit |
| 200: second transformer unit | 300: packaging unit |
| 310: first bobbin unit | 320: second bobbin unit |
| 312: first coil guide unit | 322: second coil guide unit |
| 313c: first overlapping area | 323c: second overlapping area |
| 314: first coil partition | 324: second coil partition |
| 330: bobbin coupling unit | 340: terminals |
| 350: holes | |
| 400: first coil unit | 410: first coil |
| 420: second coil | |
| 500: second coil unit | 510: third coil |
| 520: fourth coil | 600: fastener |
| 800: insulator | |
| l: overlapping length | l1: first overlapping length |
| l2: second overlapping length | |
| d1: first diameter | d2: second diameter |

### BEST MODE

Advantages and features of the present disclosure, and methods for achieving the same will be cleared with reference to embodiments described in detail later in conjunction with the accompanying drawings. However, the present disclosure is not limited to the disclosed embodiments, but may be implemented in various different forms. The embodiments are merely provided to complete the present disclosure and to fully notify a person having ordinary knowledge in the art to which the present disclosure pertains of the scope of the present disclosure. The present disclosure is merely defined by the scope of the claims.

A first, a second, etc. are used to describe various components, but the components are not restricted by the terms. The terms are used to only distinguish one component from the other components. Accordingly, a first component that is described hereinafter may be a second component within the technical spirit of the present disclosure.

Throughout the specification, the same reference numeral denotes the same component.

Characteristics of several embodiments of the present disclosure may be partially or entirely coupled or combined and may be technically variously associated and driven as may be sufficiently understood by those skilled in the art. The embodiments may be independently implemented and may be implemented in an associative relation.

Furthermore, a potential effect that has not been specifically mentioned in the specification of the present disclosure and that may be expected by technical characteristics of the present disclosure is treated as if it has been described in this specification. The present embodiment has been provided to a person having ordinary knowledge in the art to more fully describe the present disclosure. Contents illustrated in the drawings may be exaggerated and represented compared to an implementation form of an actual invention. A detailed description of a component will be omitted or described in brief if it is deemed to make the subject matter of the present disclosure unnecessarily vague.

Hereinafter, embodiments of the present disclosure are described in detail with reference to the accompanying drawings.

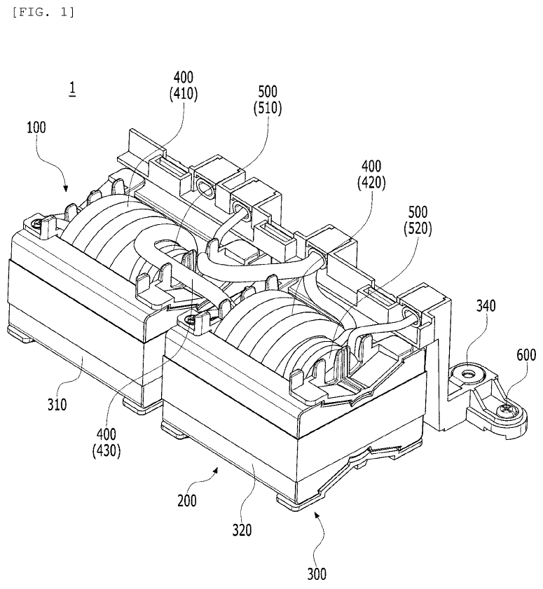

FIG. 1 is a perspective view of a transformer module 1 according to an embodiment of the present disclosure.

Referring to FIG. 1, the transformer module 1 according to an embodiment of the present disclosure may include a first transformer unit 100, a second transformer unit 200, and a packaging unit 300. More specifically, the transformer module 1 according to an embodiment of the present disclosure may include at least two transformer units 100 and 200. A power conversion apparatus (not illustrated) including the transformer module 1 according to an embodiment of the present disclosure may supply, through the respective transformer units 100 and 200, electrical energy corresponding to a rated voltage and rated current to a device that is electrically connected to an output terminal.

More specifically, the transformer module 1 according to an embodiment of the present disclosure may include the first transformer unit 100 that performs first power conversion, and the second transformer unit 200 that is spaced apart from the first transformer unit 100 and performs second power conversion. The first transformer unit 100 may transform a first input voltage to a first output voltage, and the second transformer unit 200 may transform a second input voltage to a second output voltage. The first transformer unit 100 and the second transformer unit 200 may perform voltage transformation through respective winding ratios thereof.

The transformer module 1 according to an embodiment of the present disclosure may include the packaging unit 300. The packaging unit 300 may contain the first transformer unit 100 and the second transformer unit 200 and function to connect the first transformer unit 100 and the second transformer unit 200 to a substrate (not illustrated) to allow for electrical conduction. Furthermore, the packaging unit 300 functions to safely protect the first transformer unit 100, the second transformer unit 200, and a first coil unit 400 and a second coil unit 500 that respectively form the transformer units 100 and 200 from external environment. For example, the packaging unit 300 may include bobbin units 310 and 320 around which the first coil unit 400 and the second coil unit 500 are respectively wound. The detailed configuration of the packaging unit 300 will be described later.

Hereinafter, the configuration of the first transformer unit 100 and the second transformer unit 200 will be described.

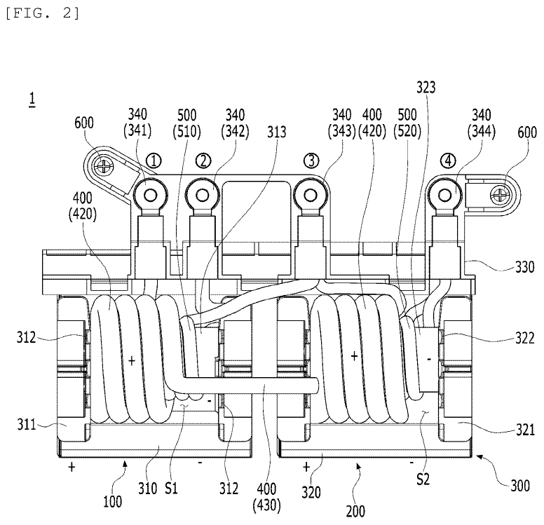

FIG. 2 is a plan view of the transformer module 1 according to an embodiment of the present disclosure.

Referring to FIGS. 1 and 2, the transformer module 1 according to an embodiment of the present disclosure may include the first coil unit 400 and the second coil unit 500. For example, the first coil unit 400 may be placed on respective input terminals of the first transformer unit 100 and the second transformer unit 200. As another example, the second coil unit 500 may be placed on respective output terminals of the first transformer unit 100 and the second transformer unit 200. With the aforementioned structure, at least a portion of the first coil unit 400 and at least a portion of the second coil unit 500 may be included in the first transformer unit 100, and a remaining portion of the first coil unit 400 and a remaining portion of the second coil unit 500 may be included in the second transformer unit 200.

In relation to the structure in which the first coil unit 400 and the second coil unit 500 are included in the first transformer unit 100 and the second transformer unit 200, the detailed configuration of the first coil unit 400 and the second coil unit 500 will be described. The first coil unit 400 may include a first coil 410 placed on the input terminal of the first transformer unit 100, and a second coil 420 placed on the input terminal of the second transformer unit 200. Here, the second coil 420 may have a structure connected in series to the first coil 410.

Furthermore, the second coil unit 500 may include a third coil 510 placed on the output terminal of the first transformer unit 100, and a fourth coil 520 placed on the output terminal of the second transformer unit 200. Here, the fourth coil 520 may have a structure connected in parallel with the third coil 510.

As described above, the structure in which the first coil 410 and the second coil 420 of the first coil unit 400 are connected in series is formed, and the structure in which the third coil 510 and the fourth coil 520 of the second coil unit 500 are connected in parallel is formed, thereby providing the advantage of simplifying a complex structure of a conventional substrate that arises from patterning a series-parallel connection structure on the substrate.

Hereinafter, some of the detailed configurations of the packaging unit 300, which is a component of the transformer module 1 according to an embodiment of the present disclosure, will be described.

Referring to FIGS. 1 and 2, the packaging unit 300, which is a component of the transformer module 1 according to an embodiment of the present disclosure, may include the first bobbin unit 310 and the second bobbin unit 320. For example, the first bobbin unit 310 may be formed on one side to receive the first transformer unit 100, and the second bobbin unit 320 may be formed on an opposite side, spaced apart from the first bobbin unit 310, to receive the second transformer unit 200.

More specifically, the first bobbin unit 310 may include a first bobbin body 311 that has a first receiving space S1 for receiving the first transformer unit 100, and a pair of first removal prevention portions that prevents at least respective portions of the first coil unit 400 and the second coil included in the first transformer unit 100 from being removed from the first bobbin unit 310. Furthermore, the first bobbin unit 310 may include a first bobbin 313 around which at least respective portions of the first coil unit 400 and the second coil unit 500, which constitute the first transformer unit 100, are wound. For example, the first bobbin 313 may have a hollow structure.

Similarly, the second bobbin unit 320 may include a second bobbin body 321 that has a second receiving space S2 for receiving the second transformer unit 200, and a pair of second removal prevention portions that prevent respective remaining portions of the first coil unit 400 and the second coil unit 500 that are included in the second transformer unit 200 from being removed from the second bobbin unit 320. Furthermore, the second bobbin unit 320 may include a second bobbin 323 around which at least respective portions of the first coil unit 400 and the second coil unit 500 that constitute the second transformer unit 200 are wound. For example, the second bobbin 323 may have a hollow structure, similar to the first bobbin 313.

Furthermore, the packaging unit 300 may further include a bobbin coupling unit 330. The bobbin coupling unit 330 may be coupled to one side of each of the first bobbin unit 310 and the second bobbin unit 320, and may be formed to secure and seat the packaging unit 300 onto the substrate. The bobbin coupling unit 330 may be coupled to the first bobbin unit 310 and the second bobbin unit 320, thus allowing the transformer module 1 to have a certain shape, and enhancing the assemblability when the transformer module 1 is secured and seated onto the substrate.

The bobbin coupling unit 330 may include a plurality of terminals 340. The plurality of terminals 340 may be coupled to electrically connect the first coil unit 400 and the second coil unit 500 to the substrate. The plurality of terminals 340 may be respectively connected to first and second ends of the first coil unit 400 and first and second ends of the second coil unit 500, so that the first coil unit 400 and the second coil unit 500 can be electrically connected, thus enabling the transformer module 1 according to an embodiment of the present disclosure to perform a voltage transformation function.

Hereinafter, detailed structures of the first coil unit 400 and the second coil unit 500 will be described.

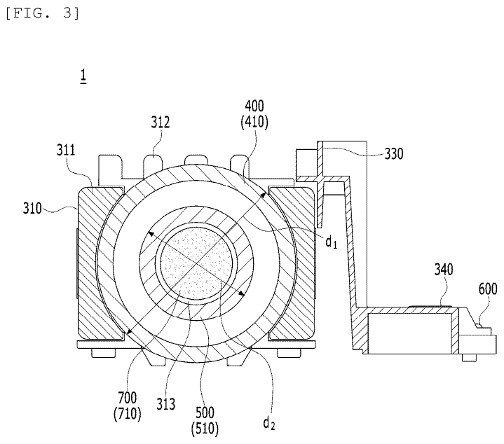

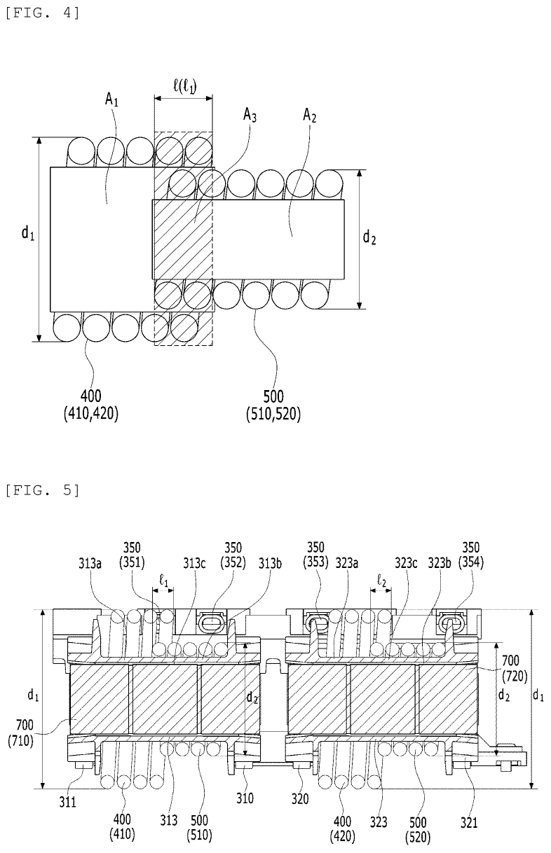

FIG. 3 is a sectional view of the transformer module 1 according to an embodiment of the present disclosure, and FIG. 4 illustrates a structure in which at least respective portions of the first coil unit 400 and the second coil unit overlap each other in the transformer module 1 according to an embodiment of the present disclosure. FIG. 5 is a sectional view of a transformer module 1 according to a first embodiment of the present disclosure.

A typical inductor-inductor-capacitor (LLC) resonant transformer may employ a structure in which an area where a primary coil is wound and an area where a secondary coil is wound are separated from each other. However, such a separated structure has an issue that there are limitations in adjusting leakage inductance of the transformer. The transformer module 1 according to an embodiment of the present disclosure may propose a structure for overcoming limitations in adjusting leakage inductance.

Referring to FIGS. 1 to 5, in the transformer module 1 according to an embodiment of the present disclosure, the first bobbin 313 of the first bobbin unit 310 may include a first winding area 313a where the first coil 410 of the first coil unit 400 is wound, and a second winding area 313b where the third coil 510 of the second coil unit 500 is wound. For example, in the first winding area 313a and the second winding area 313b, the first bobbin 313 may have a cylindrical structure having a constant diameter. However, the structure of the first bobbin 313 is not limited to the disclosed example, and as needed, structures, such as a truncated conical structure or a dual cylindrical structure, suitable for implementing the objects of the present disclosure may be applied to the shape of the first bobbin 313. Accordingly, in the first bobbin unit 310, a first winding space A1 where the first coil 410 is wound may be formed, and a second winding space A2 where the third coil 510 is wound may be formed.

Here, the first bobbin 313 of the first bobbin unit 310 may further include a first overlapping area 313c. The first overlapping area 313c may refer to an area in the first bobbin 313 where the first coil 410 and the third coil 510 overlap each other by a predetermined overlapping length (l). For example, the first coil 410 and the third coil 510 may overlap each other by a predetermined first overlapping length (l1). The first overlapping area 313c may occupy at least a portion of the first winding area 313a or the second winding area 313b. In the first overlapping area 313c, a structure in which both the first coil 410 and the third coil 510 are wound may be formed. Through the first overlapping area 313c, a first overlap space A3 may also be formed, occupying at least a portion of the first winding space A1 or the second winding space A2. Due to a structure in which the first coil 410 and the third coil 510 overlap each other by the predetermined first overlapping length (l1) in the first overlapping area 313c, first-transformer-side leakage inductance of the first transformer unit 100, which includes the first coil 410 and the third coil 510, may be adjusted. More specifically, the first-transformer-side leakage inductance may be reduced in correspondence with the first overlapping length (l1) of the first overlapping area 313c. Accordingly, the leakage inductance on the first transformer unit 100 may be minimized, and voltage transformation efficiency of the first transformer unit 100 may be maximized.

Here, to provide the structure in which the first coil 410 and the third coil 510 overlap each other by the first overlapping length (l1), the diameter of the first coil 410 and the diameter of the third coil 510 may be formed to differ from each other.

For a similar purpose, in the transformer module 1 according to an embodiment of the present disclosure, the second bobbin 323 in the second bobbin unit 320 may include a third winding area 323a where the second coil 420 in the first coil unit 400 is wound, and a fourth winding area 323b where the fourth coil 520 in the second coil unit 500 is wound. For example, in the third winding area 323a and the fourth winding area 323b, the second bobbin 323 may have a cylindrical structure with a constant diameter. However, the structure of the first bobbin 323 is not limited, and as needed, various structures may be applied to the shape of the second bobbin 323. Accordingly, in the second bobbin unit 320, a third winding space where the second coil 420 is wound may be formed, and a fourth winding space where the fourth coil 520 is wound may be formed.

Here, the second bobbin 323 in the second bobbin unit 320 may further include a second overlapping area 323c. The second overlapping area 323c may be a notion corresponding to the first overlapping area 313c of the first bobbin 313, and may refer to an area where the second coil 420 and the fourth coil 520 in the second bobbin 323 overlap each other by a set overlapping length (l). For example, the second coil 420 and the fourth coil 520 may overlap each other by a set second overlapping length (12). The second overlapping area 323c may occupy at least a portion of the third winding area 323a or the fourth winding area 323b. In the second overlapping area 323c, a structure in which both the second coil 420 and the fourth coil 520 are wound may be formed. Due to the structure in which the second coil 420 and the fourth coil 520 overlap each other by the set second overlapping length (12) in the second overlapping area 323c, second-transformer-side leakage inductance of the second transformer unit 200, which includes the second coil 420 and the fourth coil 520, may be adjusted. More specifically, in correspondence with the second overlapping length (12) of the second overlapping area 323c, the second-transformer-side leakage inductance may be reduced. Accordingly, the leakage inductance on the second transformer unit 200 may be minimized, and the transformation efficiency of the second transformer unit 200 may be maximized.

Here, to provide a structure in which the second coil 420 and the fourth coil 520 overlap each other by the second overlapping length (12), the diameter of the second coil 420 and the diameter of the fourth coil 520 may be formed to differ from each other.

The transformer module 1 according to an embodiment of the present disclosure may include at least one core 700. For example, the transformer module 1 according to an embodiment of the present disclosure may include a first core 710 that is applied to the first transformer unit 100, and a second core 720 that is applied to the second transformer unit 200. The core 700 that includes the first core 710 and the second core 720 may be a ferrite core, but is not necessarily limited to the disclosed material. The core 700 may block noise caused by a variety of frequencies and, particularly, may reliably block noise in high-frequency ranges. The first core 710 may have a cylindrical structure that is inserted into a hollow space of the first bobbin 313. The second core 720 may have a cylindrical structure that is inserted into a hollow space of the second bobbin 323. In addition, each of the first core 710 and the second core 720 may also have a structure separated into multiple parts in an axial direction.

Hereinafter, a connection relationship of distal ends (first and second ends) of the first coil unit 400 and the second coil unit 500 and a connection relationship with the above-described terminals 340 will be described.

Referring to FIGS. 1 to 5 (particularly, FIGS. 2 and 5), in the transformer module 1 according to an embodiment of the present disclosure, the plurality of terminals 340 may include a first terminal 341, a second terminal 342, a third terminal 343, and a fourth terminal 344. The first terminal 341 may be coupled to the first end of the first coil unit 400, and the second terminal 342 may be coupled to the second end of the first coil unit 400. Furthermore, the third terminal 343 may be coupled to the first end of the second coil unit 500, and the fourth terminal 344 may be coupled to the second end of the second coil unit 500.

The aforementioned coupling relationship will be described in more detail. For example, in the first coil unit 400, a first end of the first coil 410 that is located in the first transformer unit 100 may be connected to the first terminal 341 through a first hole 351 among a plurality of holes 350 formed in the bobbin coupling unit 330. As another example, in the first coil unit 400, a second end of the first coil 410 may be electrically connected in series to a first end of the second coil 420 of the first coil unit 400 through a connection bridge 430. Here, the connection bridge 430 may have a configuration in which the respective distal ends of the first coil 410 and the second coil 420 extend and traverse the first bobbin unit 310 and the second bobbin unit 320. In some cases, an outer circumferential surface of the connection bridge 430 may be covered with an insulating sheath (not illustrated) to minimize the effect of a magnetic field generated from the connection bridge 430 on other coils or to prevent short-circuiting with other coils.

Furthermore, the first end of the second coil 420 may be connected to the second end of the first coil 410 through the connection bridge 430, and the second end of the second coil 420 may be connected to the second terminal 342 through a second hole 352 among the plurality of holes 350. As such, the first coil unit 400 may have a series-connected structure, the first end of the first coil unit 400 may be connected to the first terminal 341, and the second end of the first coil unit 400 may be connected to the second terminal 342.

In the second coil unit 500, a first end of the third coil 510 that is located in the first transformer unit 100 and a first end of the fourth coil 520 may be connected to the third terminal 343 through a third hole 353 among the plurality of holes 350 formed in the bobbin coupling unit 330. As another example, in the second coil unit 500, a second end of the third coil 510 and a second end of the fourth coil 520 may be connected to the fourth terminal 344 through a fourth hole 354 among the plurality of holes 350. Here, the first end and the second end of the third coil 510 that are not wound, and the first end and the second end of the fourth coil 520 that are not wound may be covered with an insulating sheath (not illustrated) to minimize the effect of magnetic fields generated from the corresponding portions on other coils or to prevent short-circuiting with other coils. As such, the second coil unit 500 may have a parallel-connected structure, the first end of the second coil unit 500 may be connected to the third terminal 343, and the second end of the second coil unit 500 may be connected to the fourth terminal 344.

As descried above, as the first coil unit 400 and the second coil unit 500 are connected to the plurality of terminals 340 through plurality of holes 350, advantages are provided in that the opposite ends of the first coil unit 400 and the second coil unit 500 can have organized shapes, and can be easily secured and coupled to the substrate for electrical conduction.

Furthermore, the transformer module 1 according to an embodiment of the present disclosure may have a simplified series-parallel connection structure using the four terminals 340, thereby providing the advantage of improved convenience in the assembly and connection of the transformer module 1.

In addition, the plurality of terminals 340 may be coupled to the substrate by an electrically conductive connector (not illustrated), thereby enabling the transformer module 1 according to an embodiment of the present disclosure to perform a voltage transformation function.

As needed, the bobbin coupling unit 330 may be mechanically fastened to the substrate through a fastener 600 capable of fastening the packaging unit 300 to the substrate. For instance, the fastener 600 may be at least one of known fastening units including a bolt and a rivet.

Hereinafter, a relationship between diameters with which the first coil unit 400 and the second coil unit 500 are respectively wound will be described.

Referring to FIGS. 1 and 5, in the transformer module 1 according to the first embodiment of the present disclosure, the first coil unit 400 may be wound with a first diameter (d1), and the second coil unit 500 may be wound with a second diameter (d2). Here, the second diameter (d2) may be less than the first diameter (d1). Accordingly, in the case where the first coil unit 400 and the second coil unit 500 form a structure with a set mutual overlapping length (l), at least a portion of the second coil unit 500 may be inserted into the first coil unit 400. Since at least a portion of the second coil unit 500 is inserted into the first coil unit 400, advantages are provided in that leakage inductance may be adjusted (reduced) in correspondence with the overlapping length (l) in the first transformer unit 100 and the second transformer unit 200, and the voltage transformation efficiency of the transformer module 1 may be maximized.

Hereinafter, the structure of a transformer module 1 according to another embodiment of the present disclosure will be described.

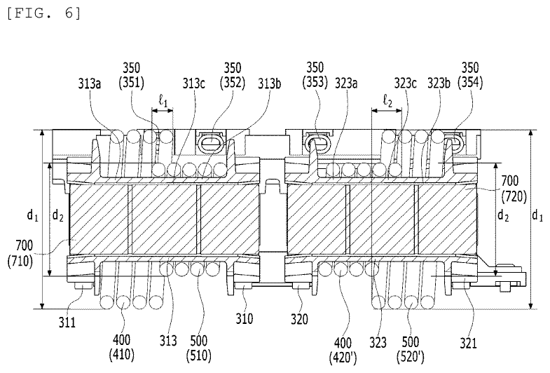

FIG. 6 is a sectional view of a transformer module 1 according to a second embodiment of the present disclosure.

Referring to FIG. 6, in the transformer module 1 according to the second embodiment of the present disclosure, a first coil 410 of a first coil unit 400 and a fourth coil 520′ of a second coil unit 500 may be wound with a first diameter (d1), and a second coil 420′ of the first coil unit 400 and a third coil 510 of the second coil unit 500 are wound with a second diameter (d2). Here, the second diameter d2 may be less than the first diameter d1. Accordingly, at least a portion of the third coil 510 may be inserted into the first coil 410, and at least a portion of the second coil 420′ may be inserted into the fourth coil 520′. Since the second coil 420′ is inserted into the fourth coil 520′ and the third coil 510 is inserted into the first coil 410, advantages are provided in that leakage inductance may be adjusted (reduced) in correspondence with the overlapping length (l) in the first transformer unit 100 and the second transformer unit 200, and the voltage transformation efficiency of the transformer module 1 may be maximized.

Hereinafter, the structure of a transformer module 1 according to another embodiment of the present disclosure will be described.

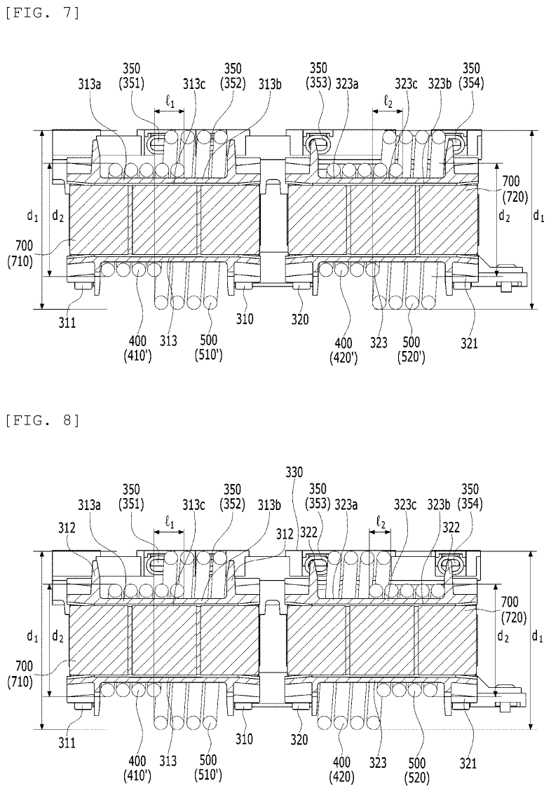

FIG. 7 is a sectional view of a transformer module 1 according to a third embodiment of the present disclosure.

Referring to FIG. 7, in the transformer module 1 according to the third embodiment of the present disclosure, a first coil unit 400 may be wound with a second diameter d2, and a second coil unit 500 may be wound with a first diameter d1. Here, the second diameter d2 may be less than the first diameter d1. Accordingly, in the case where the first coil unit 400 and the second coil unit 500 form a structure with a set mutual overlapping length (l), at least a portion of the first coil unit 400 may be inserted into the second coil unit 500. Since at least a portion of the first coil unit 400 is inserted into the second coil unit 500, advantages are provided in that leakage inductance may be adjusted (reduced) in correspondence with the overlapping length (l) in the first transformer unit 100 and the second transformer unit 200, and the voltage transformation efficiency of the transformer module 1 may be maximized.

Hereinafter, the structure of a transformer module 1 according to a fourth embodiment of the present disclosure will be described.

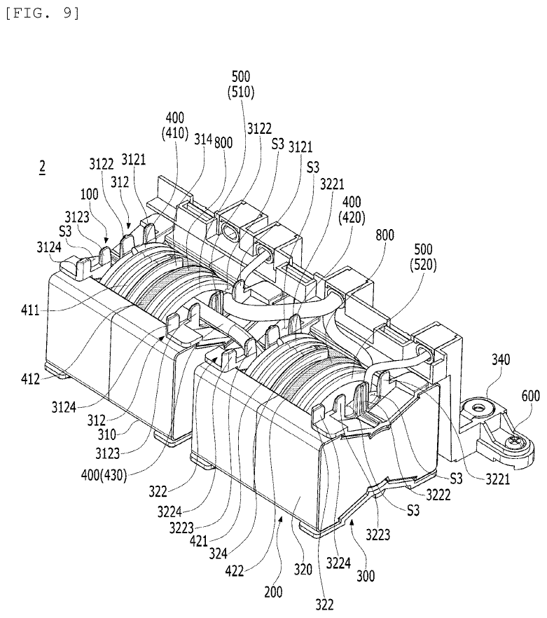

FIG. 8 is a sectional view of the transformer module 1 according to the fourth embodiment of the present disclosure.

Referring to FIG. 8, in the transformer module 1 according to the fourth embodiment of the present disclosure, a second coil 420 of a first coil unit 400 and a third coil 510′ of a second coil unit 500 may be wound with a first diameter (d1), and a first coil 410′ of the first coil unit 400 and a fourth coil 510 of the second coil unit 500 are wound with a second diameter (d2). Here, the second diameter d2 may be less than the first diameter d1. Accordingly, at least a portion of the first coil 410′ may be inserted into the third coil 510′, and at least a portion of the fourth coil 520 may be inserted into the second coil 420. Since the first coil 410′ is inserted into the third coil 510′ and the fourth coil 520 is inserted into the second coil 420, advantages are provided in that leakage inductance may be adjusted (reduced) in correspondence with the overlapping length (l) in the first transformer unit 100 and the second transformer unit 200, and the voltage transformation efficiency of the transformer module 1 may be maximized.

As described above, the transformer module 1 according to an embodiment of the present disclosure may be configured in a single package form, which simplifies the assembly strategy, thereby providing advantages such as improved assemblability, reduced assembly time, and decreased assembly costs.

Furthermore, the transformer module 1 according to an embodiment of the present disclosure may provide the advantage of maximizing voltage transformation efficiency as the leakage inductance is reduced by the overlap between the first coil unit 400 and the second coil unit 500 by a set overlapping length.

Hereinafter, the structure of a transformer module 2 according to a fifth embodiment of the present disclosure will be described.

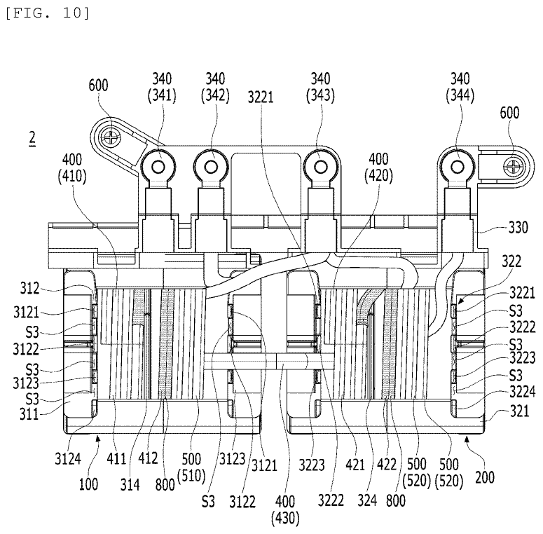

FIG. 9 is a perspective view of the transformer module 2 according to the fifth embodiment of the present disclosure. FIG. 10 is a plan view of the transformer module 2 according to the fifth embodiment of the present disclosure.

Referring to FIGS. 9 and 10, the transformer module 2 according to the fifth embodiment of the present disclosure may include components that are substantially identical to those of the transformer module 1 according to the first to fourth embodiments of the present disclosure. However, the transformer module 2 according to the fifth embodiment of the present disclosure may have some differences in the configurations of the first coil unit 400 and the second coil unit 500, and may also have some differences in the configuration of the packaging unit 300.

The transformer module 2 according to the fifth embodiment of the present disclosure may include a first transformer unit 100, a second transformer unit 200, and a packaging unit 300. Furthermore, the first transformer unit 100 may include a first coil unit 400 and a second coil unit 500. Here, at least one of the first bobbin unit 310 and the second bobbin unit 320, which are some components of the packaging unit 300, may include coil guide units 312 and 322 configured to guide at least one of the first coil unit 400 and the second coil unit 500. More specifically, the coil guide units 312 and 322 may function to guide opposite ends of at least one of the first coil 410, the second coil 420, the third coil 510, and the fourth coil 520, which are included in the first coil unit 400 and the second coil unit 500, so that the opposite ends of the at least one can be positioned at correct positions.

The coil guide units 312 and 322 may include a first coil guide unit 312 included in the first bobbin unit 310, and a second coil guide unit 322 included in the second bobbin unit 320. The first coil guide unit 312 may be formed on at least one side of the opposite sides of the first bobbin unit 310, and the second coil guide unit 322 may be formed on at least one side of the opposite sides of the second bobbin unit 320, thereby guiding the first coil unit 400 and/or the second coil unit 500.

More specifically, the coil guide units 312 and 322 may include a plurality of coil guiding columns 3121, 3122, 3123, 3124, 3221, 3222, 3223, and 3224. The plurality of coil guiding columns 3121, 3122, 3123, 3124, 3221, 3222, 3223, and 3224 may protrude upward by set heights from an edge of the first bobbin body 311 having the first receiving space S1.

The plurality of coil guiding columns 3121, 3122, 3123, 3124, 3221, 3222, 3223, and 3224 may serve as a type of partition walls to prevent the coils 410, 420, 510, and 520 included in the first coil unit 400 and the second coil unit 500, respectively, from being displaced from correct positions thereof. As illustrated in FIGS. 9 and 10, with regard to the plurality of coil guiding columns 3121, 3122, 3123, 3124, 3221, 3222, 3223, and 3224, the first coil guide unit 312 is expressed as including four first-bobbin-side coil guiding columns 3121, 3122, 3123, and 3124 on each of the opposite sides of the first bobbin unit 310, and the second coil guide unit 322 is expressed as including four second-bobbin-side coil guiding columns 3221, 3222, 3223, and 3224 on each of the opposite sides of the second bobbin unit 320. However, the number of columns is not limited to the specified quantity.

Furthermore, by the plurality of coil guiding columns 3121, 3122, 3123, 3124, 3221, 3222, 3223, and 3224, the coil guide units 312 and 322 may include at least one coil passing space S3 formed between the plurality of coil guiding columns 3121, 3122, 3123, 3124, 3221, 3222, 3223, and 3224. One end or opposite ends of at least one of the first coil 410, the second coil 420, the third coil 420, the third coil 510, and the fourth coil 520, described above, may be stably received in the coil passing space S3, so that advantages are provided in that the opposite ends of the first coil unit 400 and the second coil unit 500 can be organized, thereby enabling the transformer module 2 to have a compact shape.

Hereinafter, a configuration for preventing short-circuiting due to mutual contact in the structure in which the first coil unit 400 and the second coil unit 500 overlap each other by a set length in the overlapping area 313c or 323c will be described.

Referring to FIGS. 9 and 10, in the transformer module 2 according to the fifth embodiment of the present disclosure, the first bobbin unit 310 may include a first coil partition 314 that separates the first winding area 313a and the second winding area 313b from each other, and the second bobbin unit 320 may include a second coil partition 324 that separates the third winding area 323a and the fourth winding area 323b from each other. The first coil partition 314 may have an outer diameter greater than that of the first bobbin 313 to prevent mutual interference between the first winding area 313a and the second winding area 313b, where the first coil 410 of the first coil unit 400 and the third coil 510 of the second coil unit 500 are respectively wound. The second coil partition 324 may have an outer diameter greater than that of the second bobbin 323 to prevent mutual interference between the third winding area 323a and the fourth winding area 323b, where the second coil 420 of the first coil unit 400 and the fourth coil 520 of the second coil unit 500 are respectively wound.

Here, either the first coil unit 400 and the second coil unit 500 may extend into a winding area where the other is wound, thus forming the overlapping areas 313c and 323c. For example, the first coil 410 of the first coil unit 400 may extend into the second winding area 313b, where the third coil 510 is wound, thus forming the first overlapping area 313c. For specifically, a portion of the first coil 410 of the first coil unit 400 may cross over the first coil partition 314 and extend into the second winding area 313b, where the third coil 510 is wound, thus forming the first overlapping area 313c.

As another example, the second coil 420 of the first coil unit 400 may extend into the fourth winding area 323b, where the fourth coil 520 is wound, thus forming the second overlapping area 323c. For specifically, a portion of the second coil 420 of the first coil unit 400 may cross over the second coil partition 324 and extend into the fourth winding area 323b, where the fourth coil 520 is wound, thus forming the second overlapping area 323c.

However, the foregoing is merely illustrative, and it is also possible for a portion of the third coil 510 to cross over the first coil partition 314 and extend into the first winding area 313a, where the first coil 410 is wound, thus forming the first overlapping area 313c, or it is also possible for a portion of the fourth coil 520 to cross over the second coil partition 324 and extend into the third winding area 323a, where the second coil 420 is wound, thus forming the second overlapping area 323c. As another example, the first overlapping area 313c may be formed by a structure in which the first coil 410 extends into the second winding area 313b, where the third coil 510 is wound, and the second overlapping area 323c may be formed by a structure in which the fourth coil 520 extends into the third winding area 323a, where the second coil 420 is wound, or vice versa.

Since at least a portion of the first coil 410 crosses over the first coil partition 314 and extends into the second winding area 313b, a diameter of at least a portion of the first coil 410 wound in the first overlapping area 313c may be formed to be greater than that of the third coil 510 wound in the second winding area 313b. A diameter of a remaining portion of the first coil 410 wound in the first winding area 313a may be formed to correspond to the diameter of the third coil 510 wound in the second winding area 313b. For example, the diameter of the remaining portion of the first coil 410 wound in the first winding area 313a and the diameter of the third coil 510 wound in the second winding area 313b may each correspond to a second diameter (d2), and the diameter of at least the portion of the first coil 410 wound in the first overlapping area 313c may correspond to a first diameter d1. Furthermore, as the first coil 410 wound in the first overlapping area 313c crosses over the first coil partition 314, the winding diameter of the first coil 410 may gradually increase from the first winding area 313a toward the second winding area 313b, ultimately reaching the first diameter (d1).

For a similar purpose, since at least a portion of the second coil 420 crosses over the second coil partition 324 and extends into the fourth winding area 323b, a diameter of at least a portion of the second coil 420 wound in the second overlapping area 323c may be formed to be greater than that of the fourth coil 520 wound in the fourth winding area 323b. A diameter of a remaining portion of the second coil 420 wound in the third winding area 323a may be formed to correspond to the diameter of the fourth coil 520 wound in the fourth winding area 323b. For example, the diameter of the remaining portion of the second coil 420 wound in the third winding area 323a and the diameter of the fourth coil 520 wound in the fourth winding area 323b may correspond to the second diameter (d2), and the diameter of at least the portion of the second coil 420 wound in the second overlapping area 323c may be the first diameter d1. Furthermore, as the second coil 420 wound in the second overlapping area 323c crosses over the second coil partition 324, the winding diameter of the second coil 420 may gradually increase from the third winding area 323a toward the fourth winding area 323b, ultimately reaching the first diameter (d1).

However, during a process in which the first coil unit 400 and the second coil unit 500 form the overlapping areas 313c and 323c for adjusting the leakage inductance, there are concerns regarding damage, functional degradation, and electrical accidents of the transformer module due to short-circuiting if an outer circumferential surface of the wound first coil unit 400 and an outer circumferential surface of the wound second coil unit 500 come into contact with each other. To overcome the aforementioned problems, the transformer module 2 according to the fifth embodiment of the present disclosure may further include an insulator 800. The insulator 800 may cover the outer circumferential surface of at least one of a portion of the first coil 410 that forms the first overlapping area 313c, and a portion of the third coil 510 that forms the first overlapping area 313c, or may cover the outer circumferential surface of at least one of a portion of the second coil 420 that forms the second overlapping area 323c, and a portion of the fourth coil 520 that forms the second overlapping area 323c. The insulator may be formed of a material with low electrical conductivity, and may prevent mutual physical contact between the first coil unit 400 and the second coil unit 500 in the first overlapping area 313c and the second overlapping area 323c. Accordingly, due to the configuration of the insulator 800, mutual physical contact between the first coil unit 400 and the second coil unit 500 in areas vulnerable to withstand voltage stress may be prevented, thereby avoiding functional degradation and electrical accidents due to short-circuiting, and allowing for easy adjustment of leakage inductance so that desired voltage transformation performance can be achieved.

As needed, the characteristic configuration of the transformer module 2 according to the fifth embodiment of the present disclosure may be applied entirely or selectively to the transformer module 1 according to the first to fourth embodiments of the present disclosure. For example, in a structure similar to the transformer module 1 according to the first to fourth embodiments of the present disclosure, the first coil guide unit 312 and the second coil guide unit 322 may be formed, and the insulator 800 covering the outer circumferential surfaces of the first coil unit 400 and the second coil unit 500, which correspond to at least one of the first overlapping area 313c and the second overlapping area 323c may be further included.

Although the preferred embodiments of the present disclosure have been described above, the present disclosure is not limited to the embodiments, but may be modified and embodied in various ways within the claims, the detailed description of the present disclosure, and the accompanying drawings, which may also belong to the scope of the present disclosure.

### INDUSTRIAL APPLICABILITY

The present disclosure may provide a transformer module in which coils are wound in a single package form, implementing a series, parallel, or series-parallel hybrid connection configuration in a package rather than on a substrate.

1. A transformer module comprising:
a first transformer unit configured to perform first power conversion;
a second transformer unit spaced apart from the first transformer unit, and configured to perform second power conversion; and
a packaging unit including the first transformer unit and the second transformer unit, and connecting the first transformer unit and the second transformer unit to a substrate to allow for electrical conduction,
wherein the packaging unit comprises:
a first bobbin unit formed on one side to receive the first transformer unit; and
a second bobbin unit formed on an opposite side spaced apart from the first bobbin unit to receive the second transformer unit.

2. The transformer module of claim 1, further comprising:
a first coil unit placed on respective input terminals of the first transformer unit and the second transformer unit; and
a second coil unit placed on respective output terminals of the first transformer unit and the second transformer unit,
wherein at least a portion of the first coil unit and at least a portion of the second coil unit are included in the first transformer unit, and a remaining portion of the first coil unit and a remaining portion of the second coil unit are included in the second transformer unit.

3. The transformer module of claim 2,
wherein the first coil unit comprises:
a first coil placed on the input terminal of the first transformer unit; and
a second coil connected in series to the first coil, and placed on the input terminal of the second transformer unit, and
wherein the second coil unit comprises:
a third coil placed on the output terminal of the first transformer unit; and
a fourth coil connected in parallel with the third coil, and placed on the output terminal of the second transformer unit.

4. The transformer module of claim 3,
wherein the first bobbin unit includes a first winding area where the first coil is wound, a second winding area where the third coil is wound, and a first overlapping area where the first coil and the third coil overlap each other by a first overlapping length,
wherein the first overlapping area occupies at least a portion of the first winding area or the second winding area,
wherein the second bobbin unit includes a third winding area where the second coil is wound, a fourth winding area where the fourth coil is wound, and a second overlapping area where the second coil and the fourth coil overlap each other by a second overlapping length, and
wherein the second overlapping area occupies at least a portion of the third winding area or the fourth winding area.

5. The transformer module of claim 4,
wherein leakage inductance on the first transformer unit is adjusted in correspondence with the first overlapping length of the first overlapping area, and
wherein leakage inductance on the second transformer unit is adjusted in correspondence with the second overlapping length of the second overlapping area.

6. The transformer module of claim 3,
wherein the packaging unit further comprises a bobbin coupling unit coupled to one side of each of the first bobbin unit and the second bobbin unit, and provided to secure and seat the packaging unit on the substrate, and
wherein the bobbin coupling unit comprises a plurality of terminals by which the first coil unit and the second coil unit are connected to the substrate to allow for electrical conduction.

7. The transformer module of claim 6,
wherein the plurality of terminals comprise a first terminal to which a first end of the first coil unit is coupled, a second terminal to which a second end of the first coil unit is coupled, a third terminal to which a first end of the second coil unit is coupled, and a fourth terminal to which a second end of the second coil unit is coupled,
wherein a first end of the first coil in the first coil unit is connected to the first terminal through a first hole among a plurality of holes formed in the bobbin coupling unit,
wherein a second end of the first coil is electrically connected to a first end of the second coil in the first coil unit through a connection bridge, and
wherein a second end of the second coil is connected to the second terminal through a second hole among the plurality of holes.

8. The transformer module of claim 7,
wherein a first end of the third coil and a first end of the fourth coil in the second coil unit are connected to the third terminal through a third hole among the plurality of holes, and
wherein a second end of the third coil and a second end of the fourth coil are connected to the fourth terminal through a fourth hole among the plurality of holes.

9. The transformer module of claim 3, wherein the first coil unit is wound with a first diameter, and the second coil unit is wound with a second diameter less than the first diameter, so that at least a portion of the second coil unit is inserted into the first coil unit.

10. The transformer module of claim 3, wherein the first coil in the first coil unit and the fourth coil in the second coil unit are wound with a first diameter, and the second coil in the first coil unit and the third coil in the second coil unit are wound with a second diameter less than the first diameter, so that at least a portion of the third coil is inserted into the first coil, and at least a portion of the second coil is inserted into the fourth coil.

11. The transformer module of claim 3, wherein the first coil unit is wound with a second diameter, and the second coil unit is wound with a first diameter greater than the second diameter, so that at least a portion of the first coil unit is inserted into the second coil unit.

12. The transformer module of claim 3, wherein the second coil in the first coil unit and the third coil in the second coil unit are wound with a first diameter, and the first coil in the first coil unit and the fourth coil in the second coil unit are wound with a second diameter less than the first diameter, so that at least a portion of the first coil is inserted into the third coil, and at least a portion of the fourth coil is inserted into the second coil.

13. The transformer module of claim 2,
wherein at least one of the first bobbin unit and the second bobbin unit comprises a coil guide unit configured to guide at least one of the first coil unit and the second coil unit, and
wherein the coil guide unit comprises a plurality of coil guiding columns formed to protrude upward by a set height, and at least one coil passing space formed between the plurality of coil guiding columns.

14. The transformer module of claim 4,
wherein the first bobbin unit comprises a first coil partition configured to separate the first winding area and the second winding area, and
wherein the second bobbin unit comprises a second coil partition configured to separate the third winding area and the fourth winding area.

15. The transformer module of claim 14,
wherein a portion of the first coil in the first coil unit crosses over the first coil partition, extends into the second winding area, in which the third coil is wound, and forms the first overlapping area, and
wherein a portion of the second coil in the first coil unit crosses over the second coil partition, extends into the fourth winding area, in which the fourth coil is wound, and forms the second overlapping area.

16. The transformer module of claim 15, further comprising an insulator covering an outer circumferential surface of at least one of the portion of the first coil that forms the first overlapping area and the portion of the third coil that forms the first overlapping area, or covering an outer circumferential surface of at least one of the portion of the second coil that forms the second overlapping area and the portion of the fourth coil that forms the second overlapping area.
